(19) United States
(12) Patent Application Publication
(10) Pub. No.: US 2025/0300182 A1
(43) Pub. Date: Sep. 25, 2025

(54) IONIC POLYMER BINDER, AND PREPARATION METHOD AND USE THEREOF

(71) Applicant: Nankai University, Nankai District (CN)

(72) Inventors: Wangqing ZHANG, Nankai District (CN); Yuanyuan XU, Nankai District (CN)

(21) Appl. No.: 18/904,204

(22) Filed: Oct. 2, 2024

(30) Foreign Application Priority Data
Mar. 22, 2024 (CN) 202410332019.X

(51) Int. Cl. H01M 4/62; C08G 65/00; H01M 4/02; H01M 4/04; H01M 10/0525

(52) U.S. Cl. CPC H01M 4/622; C08G 65/002; H01M 4/0404; H01M 10/0525; H01M 2004/028

(57) ABSTRACT

An ionic polymer binder having a chemical structure shown in formula I or formula II is provided. An interaction between hexafluorophosphate group in the ionic polymer binder and a cathode active material could enhance bonding among the materials, improve the conductivity of lithium ions, and increase an active material loading capacity of the cathode.

### CROSS REFERENCE TO RELATED APPLICATION

This patent application claims the benefit and priority of Chinese Patent Application No. 202410332019X, entitled “Ionic polymer binder, and preparation method and use thereof” filed on Mar. 22, 2024, the disclosure of which is incorporated by reference herein in its entirety as part of the present application.

### TECHNICAL FIELD

The present disclosure relates to the technical field of lithium-ion batteries, and in particular to an ionic polymer binder, and a preparation method and use thereof.

### BACKGROUND

With the need of “carbon neutrality”, the research and development of energy storage technology have become a focus. Lithium-ion batteries, as a new type of energy device that has been commercialized, have high specific energy, long recycling life and excellent safety performance, and are used in the fields such as mobile electronic devices and electric vehicles. A lithium-ion battery mainly includes five parts: a cathode, a separator, an anode, an electrolyte, and a battery casing, wherein the bonding strength among cathode/anode materials and a conductive agent and a current collector shows a significant impact on a recycling stability of the battery.

Currently, commercial cathode binders are mainly polyvinylidene fluoride (PVDF), which exhibits desirable antioxidant ability and chemical reaction inertness. However, a bonding effect of the PVDF generally comes from Van der Waal's force and hydrogen bonds formed by C—F bonds on a main chain with other substances, and could cause the active materials to pulverize and to fall off the current collector during recycling, thereby adversely affecting the recycling stability of the battery. Therefore, it has become a technical problem that needs to be solved urgently in this field to improve the bonding performance of the binder and the recycling stability of the battery assembled using the binder.

### SUMMARY

An object of the present disclosure is to provide an ionic polymer binder, and a preparation method and use thereof. In the present disclosure, the ionic polymer binder has excellent bonding capability and realizes high loading of cathode active materials; and a lithium-ion battery assembled therefrom has high specific capacity, capacity retention, and recycling stability.

To achieve the above object, the present disclosure provides the following technical solutions:

The present disclosure provides an ionic polymer binder having a chemical structure shown in formula I or formula II:

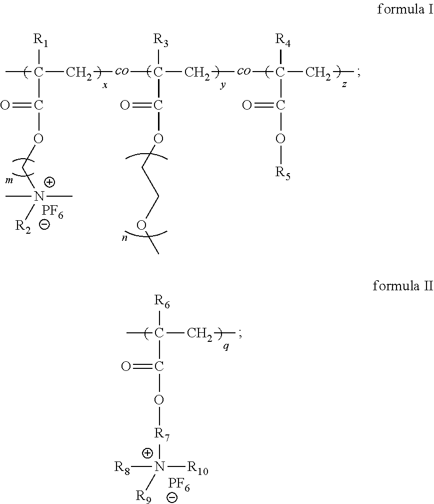

wherein
in formula I, R₁, R₃, and R₄ are independently selected from the group consisting of hydrogen and alkyl, and R₂ and R₅ are independently alkyl; and
in formula II, R₆ is selected from the group consisting of hydrogen and alkyl, R₇ is selected from the group consisting of alkylene and aralkylene, R₅ and R₉ are independently selected from the group consisting of alkyl and aralkyl, and R₁₀ is alkyl.

In some embodiments, in formula I, m is in a range of 1 to 3; n is in a range of 4 to 40; and x, y, and z satisfy x+y+z=1, where x>0, y>0, and z≥0.

In some embodiments, in formula II, q represents a degree of polymerization and is in a range of 20 to 2,000.

The present disclosure further provides a method for preparing the ionic polymer binder as described in the above technical solutions, including the following steps:
(1) mixing a monomer, a first initiator, and a first organic solvent, and subjecting a resulting mixture to a first free radical polymerization, to obtain a first polymer solution;
(2) mixing a first halogenated hydrocarbon, a second solvent, and the first polymer solution obtained in step (1), and subjecting a resulting mixture to a first quaternization reaction, to obtain a second polymer solution; and
(3) mixing the second polymer solution obtained in step (2) with an aqueous solution of a first fluorophosphate, and subjecting a resulting mixture to a first ion exchange reaction, to obtain the ionic polymer binder.

Under the condition that the monomer in step (1) is a dialkylamino acrylate, the ionic polymer binder having the chemical structure shown in formula II is obtained.

Under the condition that the monomer in step (1) is a mixture of a dialkylamino acrylate and polyethylene glycol acrylate, the ionic polymer binder having the chemical structure shown in formula I where z=0 is obtained.

Under the condition that the monomer in step (1) is a mixture of a dialkylamino acrylate, polyethylene glycol acrylate, and an acrylate, the ionic polymer binder having the chemical structure shown in formula I where z>0 is obtained.

In some embodiments, the first free radical polymerization in step (1) is conducted at a temperature of 45° C. to 80° C. for 6 h to 24 h.

In some embodiments, the first quaternization reaction in step (2) is conducted at a temperature of 10° C. to 45° C. for 1 h to 12 h.

In some embodiments, the first ion exchange reaction in step (3) is conducted at a temperature of 10° C. to 45° C. for 1 h to 12 h.

The present disclosure further provides a method for preparing the ionic polymer binder as described in above technical solutions, including the following steps:
1) mixing a dialkylamino acrylate, water, and a second halogenated hydrocarbon, and subjecting a resulting mixture to a second quaternization reaction, to obtain an aqueous trialkylamino acrylate halide solution;

2) mixing the aqueous trialkylamino acrylate halide solution obtained in step 1) with an aqueous solution of a second fluorophosphate, and subjecting a resulting mixture to a second ion exchange reaction, to obtain a trialkylamino acrylate fluorophosphate; and

3) mixing the trialkylamino acrylate fluorophosphate obtained in step 2), polyethylene glycol acrylate, an acrylate, a second initiator, and water, and subjecting a resulting mixture to a second free radical polymerization, to obtain the ionic polymer binder having the chemical structure shown in formula I where z>0.

Under the condition that the acrylate in step 3) is omitted, the ionic polymer binder having the chemical structure shown in formula I where z=0 is obtained; and

Under the condition that the polyethylene glycol acrylate and the acrylate in step 3) are omitted, the ionic polymer binder having the chemical structure shown in formula II is obtained.

The present disclosure further provides use of the ionic polymer binder as described in the above technical solutions or the ionic polymer binder prepared by the method as described in the above technical solutions in a cathode of a lithium-ion battery.

In some embodiments, the cathode of a lithium-ion battery is prepared by a process including the following steps:
(i) mixing the ionic polymer binder with a second organic solvent, to obtain a binder solution;
(ii) mixing an active material with a conductive agent, to obtain a mixed powder;
(iii) mixing the binder solution obtained in step (i), the mixed powder obtained in step (ii), and a third organic solvent, to obtain a cathode slurry; and
(iv) applying the cathode slurry obtained in step (iii) onto a current collector, to obtain the cathode of the lithium-ion battery;
wherein step (i) and step (ii) are conducted in any order.

An ionic polymer binder having a chemical structure shown in formula I or formula II is provided. An interaction between hexafluorophosphate group in the ionic polymer binder and a cathode active material could enhance bonding among the materials, improve the conductivity of lithium ions, and increase an active material loading capacity of the cathode. Therefore, a lithium-ion battery assembled using the ionic polymer binder has a large specific capacity, a desirable recycling stability, and a long service life. The results of examples show that at a current density of 0.5 C, a battery assembled using the ionic polymer binder could still maintain 137.8 mAh g⁻¹ after 800 cycles, thus showing capacity retention of 92.11%; moreover, the battery could still maintain 127.1 mAh g⁻¹ after 1,000 cycles, thus showing capacity retention of 85.02%. This indicates that the battery has excellent recycling performance.

### BRIEF DESCRIPTION OF THE DRAWINGS

FIG. 1 shows a nuclear magnetic resonance (1H-NMR) spectrum of the ionic polymer binder prepared in Example 1.

FIG. 2 shows an 1H-NMR spectrum of trimethylaminoethyl acrylate fluorophosphonate in Example 5.

FIG. 3 shows an 1H-NMR spectrum of the ionic polymer binder prepared in Example 9.

FIG. 4 shows a long recycling charge-discharge curve of the battery assembled with C1 as a battery cathode and lithium metal as a battery anode at 25° C., with a cut-off voltage of 2.5 V to 4.2 V, and a rate of 0.5 C.

FIG. 5 shows charge-discharge curves of the battery assembled with C1 as a battery cathode and lithium metal as a battery anode at 25° C., with a cut-off voltage of 2.5 V to 4.2 V, and different rates of 0.1 C, 0.2 C, and 0.5 C.

FIG. 6 shows a long recycling charge-discharge curve of the battery assembled with C17 as a battery cathode and lithium metal as a battery anode at 25° C., with a cut-off voltage of 2.5 V to 4.2 V, and a rate of 0.5 C.

FIG. 7 shows charge-discharge curves of the battery assembled with C17 as a battery cathode and lithium metal as a battery anode at 25° C., with a cut-off voltage of 2.5 V to 4.2 V, and different rates of 0.1 C, 0.2 C, and 0.5 C.

FIG. 8 shows a long recycling charge-discharge curve of the lithium iron phosphate/artificial graphite battery assembled with C1 as a cathode and C22 as an anode at 25° C., with a cut-off voltage of 2.5 V to 4.2 V, and a rate of 0.5 C.

FIG. 9 shows a long recycling charge-discharge curve of the lithium iron phosphate/artificial graphite battery assembled with C17 as a cathode and C22 as an anode at 25° C., with a cut-off voltage of 2.5 V to 4.2 V, and a rate of 0.5 C.

### DETAILED DESCRIPTION OF THE EMBODIMENTS

### Definition

In this text, x, y, and z separately represent mole fractions of corresponding repeating units in a polymer main chain with the proviso that a sum of x, y, and z is 100% (that is to say, x+y+z=1).

The present disclosure provides an ionic polymer binder having a chemical structure shown in formula I or formula II:

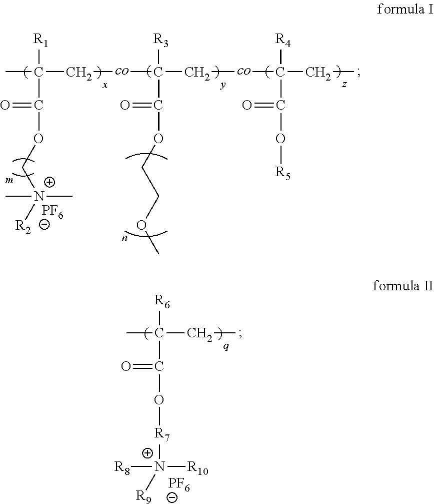

wherein
in formula I, R₁, R₃, and R₄ are independently selected from the group consisting of hydrogen and alkyl, and R₂ and R₅ are independently alkyl; and
in formula II, R₆ is selected from the group consisting of hydrogen and alkyl, R₇ is selected from the group consisting of alkylene and aralkylene, R₅ and R₉ are independently selected from the group consisting of alkyl and aralkyl, and R₁₀ is alkyl.

In one technical solution of the present disclosure, the ionic polymer binder has a chemical structure shown in formula I:

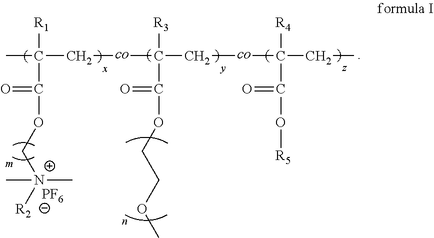

In the present disclosure, in formula I, R₁, R₃, and R₄ are independently selected from the group consisting of hydrogen and alkyl, R₂ and R₅ are independently alkyl, and the alkyl is preferably methyl or butyl.

In some embodiments of the present disclosure, in formula I, m is in a range of 1 to 3; n is in a range of 4 to 40; and x, y, and z satisfy x+y+z=1, preferably x>0, y>0, and z≥0.

In the present disclosure, an interaction between hexafluorophosphate group in the ionic polymer binder and a cathode active material could enhance bonding between the materials and the conductivity of lithium ions; the polyethylene glycol acrylate could improve the flexibility of the binder and soften the electrode; the introduction of the acrylate as a hydrophobic segment reduces the hydrophilicity of the polymer, thus avoiding a decrease in battery capacity and recycling performance after the active material absorbs water. This makes a lithium-ion battery assembled using the binder have a relatively high specific capacity, capacity retention, and recycling stability.

In another technical solution of the present disclosure, the ionic polymer binder has a chemical structure shown in formula II:

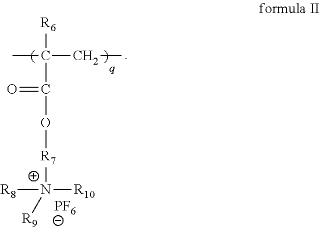

In the present disclosure, in formula II, R₆ is hydrogen or alkyl, and the alkyl is preferably methyl or ethyl; R₇ is alkylene or arylalkylene, and the alkylene is preferably ethylene group or propylene, and the arylalkylene is preferably diphenyl; R₈ and R₉ are independently alkyl or arylalkyl, and the alkyl is preferably methyl, and the arylalkyl is preferably benzyl; R₁₀ is alkyl, and the alkyl is preferably methyl.

In the present disclosure, in formula II, q represents a degree of polymerization and is preferably in a range of 20 to 2,000.

When the ionic polymer binder provided in the present disclosure is used to prepare a cathode of a lithium-ion battery, an interaction between hexafluorophosphate group in the ionic polymer binder and a cathode active material could enhance bonding among the materials and conductivity of lithium ions, and increase an active material loading capacity of the cathode. The prepared electrode is smooth without curling or cracking. Therefore, a lithium-ion battery assembled using the binder has a large specific capacity, a desirable recycling stability, and a long service life.

The present disclosure further provides a method for preparing the ionic polymer binder, including the following steps:
(1) mixing a monomer, a first initiator, and a first organic solvent, subjecting a resulting mixture to a first free radical polymerization, to obtain a first polymer solution;
(2) mixing a first halogenated hydrocarbon, a second solvent, and the first polymer solution obtained in step (1), subjecting a resulting mixture to a first quaternization reaction, to obtain a second polymer solution; and
(3) mixing the second polymer solution obtained in step (2) with an aqueous solution of a first fluorophosphate, subjecting a resulting mixture to a first ion exchange reaction, to obtain the ionic polymer binder; wherein
under the condition that the monomer in step (1) is a dialkylamino acrylate, the ionic polymer binder having the chemical structure shown in formula II is obtained;
under the condition that the monomer in step (1) is a mixture of a dialkylamino acrylate and polyethylene glycol acrylate, the ionic polymer binder having the chemical structure shown in formula I where z=0 is obtained; and
under the condition that the monomer in step (1) is a mixture of a dialkylamino acrylate, polyethylene glycol acrylate, and an acrylate, the ionic polymer binder having the chemical structure shown in formula I where z>0 is obtained.

In the present disclosure, there is no special limitation on a source of each raw material, and commercially available products well known to those skilled in the art may be used.

In the present disclosure, a monomer, a first initiator, and a first organic solvent are mixed, and a resulting mixture is subjected to a first free radical polymerization, to obtain a first polymer solution.

In some embodiments of the present disclosure, the monomer is at least one selected from the group consisting of a dialkylamino acrylate, polyethylene glycol acrylate, and an acrylate.

In the present disclosure, the ionic polymer binder having the chemical structure shown in formula II is obtained with the monomer of dialkylamino acrylate.

In the present disclosure, under the condition that the monomer is a mixture of a dialkylamino acrylate and polyethylene glycol acrylate, the ionic polymer binder having the chemical structure shown in formula I where z=0 is obtained. In some embodiments, a molar ratio of the dialkylamino acrylate to the polyethylene glycol acrylate is in a range of 1:(0.1-1.1), preferably 1:(0.5-1.0). The molar ratio of the dialkylamino acrylate to the polyethylene glycol acrylate within the above range could allow the free radical polymerization to proceed fully and could allow the binder to have better bonding performance.

In the present disclosure, under the condition with the monomer mixture of a dialkylamino acrylate, polyethylene glycol acrylate, and an acrylate, the ionic polymer binder having the chemical structure shown in formula I where z>0 is obtained. In some embodiments, a molar ratio of the dialkylamino acrylate, the polyethylene glycol acrylate, and the acrylate is in a range of 1:(0.1-1.1):(0.1-1.1), and preferably 1:(0.5-1.0):(0.5-1.0). The molar ratio of the dialkylamino acrylate, the polyethylene glycol acrylate, and the acrylate within the above range could allow the free radical polymerization to proceed fully and could allow the binder to have better bonding performance.

In some embodiments of the present disclosure, the dialkylamino acrylate is one or more of dimethylaminoethyl acrylate, dimethylaminoethyl methacrylate, 3-(dimethylamino)propyl methacrylate, and 4′-(di-p-tolylamino)-[1,1′-biphenyl]-4-yl acrylate.

In some embodiments of the present disclosure, the polyethylene glycol acrylate is poly(ethylene glycol) methyl ether acrylate and/or poly(ethylene glycol) methyl ether methacrylate.

In some embodiments of the present disclosure, the acrylate is one or more of butyl acrylate, butyl methacrylate, 2-ethylbutyl acrylate, and pentyl acrylate.

In some embodiments of the present disclosure, the first initiator is one or more of azobisisobutyronitrile (AIBN), 1,1′-azobis(cyclohexane-1-carbonitrile) (ACCN), dimethyl 2,2′-azodiisobutyrate, and dibenzoyl peroxide (BPO), and preferably the AIBN, ACCN, or dimethyl 2,2′-azodiisobutyrate. In the present disclosure, the first initiator could initiate free radical polymerization of the monomer.

In some embodiments of the present disclosure, the first organic solvent includes one or more of dimethyl carbonate (DMC), ethanol, ether, acetonitrile, toluene, acetone, N-methylpyrrolidone (NMP), N,N-dimethylformamide (DMF), tetrahydrofuran (THF), dichloromethane (DCM), and chloroform. The first organic solvent listed above shows high compatibility with various raw materials, thereby ensuring that the free radical polymerization is fully conducted.

In some embodiments of the present disclosure, a mass of the first initiator is 0.1% to 2%, and preferably 0.4% to 1.5% of that of the monomer. Controlling the amount of the initiator within the above range could promote the free radical polymerization to proceed fully.

In the present disclosure, there is no particular limitation on a mass of the first organic solvent, as long as a mass concentration of the monomer is within the range of 10% to 50%, preferably 20% to 30%. Controlling the amount of the first organic solvent within the above range could promote the free radical polymerization to proceed fully.

In the present disclosure, there is no particular limitation on an operation of mixing the monomer, the first initiator, and the first organic solvent, as long as the above components could be uniformly mixed, and a mixing process well known to those skilled in the art may be used.

In some embodiments of the present disclosure, the first free radical polymerization is conducted at a temperature of 45° C. to 80° C., preferably 60° C. to 70° C. In some embodiments, the first free radical polymerization is conducted for 6 h to 24 h, preferably 8 h to 15 h. The temperature and time of the free radical polymerization within the above ranges enable the free radical polymerization to proceed fully.

In some embodiments of the present disclosure, the first free radical polymerization is conducted in inert atmosphere. In some embodiments, the inert atmosphere is nitrogen or argon. The inert atmosphere could prevent air from interfering with the free radical polymerization.

In some embodiments of the present disclosure, after obtaining the first polymer solution, a first halogenated hydrocarbon, a second solvent, and the first polymer solution are mixed, and a resulting mixture is subjected to a first quaternization reaction, to obtain a second polymer solution.

In some embodiments of the present disclosure, the first halogenated hydrocarbon is at least one of methyl iodide, ethyl bromide, propyl bromide, and 1-chlorobutane. Under the condition that the first halogenated hydrocarbon is two or more of the above, there is no particular limitation on a ratio between the two or more, and they could be mixed in any ratio. The halogenated hydrocarbon undergoes quaternization reaction with a dialkylamino group in the dialkylamino acrylate, such that the dialkylamino acrylate is converted into a quaternary ammonium salt.

In some embodiments of the present disclosure, the second solvent is one or more of DMC, ethanol, ether, acetonitrile, toluene, acetone, NMP, DMF, THF, DCM, and chloroform.

In some embodiments of the present disclosure, a molar ratio of the dialkylamino acrylate to the first halogenated hydrocarbon is in a range of (0.5-1):(0.5-1), and preferably (0.5-0.8):(0.5-0.8). Controlling the ratio between the two could make each component react fully.

In some embodiments of the present disclosure, the mixing of the first halogenated hydrocarbon, the second solvent, and the first polymer solution includes: mixing the first halogenated hydrocarbon with the second solvent, and then adding a resulting mixture dropwise into the first polymer solution. There is no particular limitation on a rate of the adding dropwise, which could be determined based on common sense. The adding dropwise could avoid overheating resulted from the reaction.

In the present disclosure, there is no particular limitation on the amount of the second solvent, as long as a content of the first halogenated hydrocarbon in the mixture obtained by mixing the first halogenated hydrocarbon with the second solvent is within 30 wt % to 50 wt %.

In some embodiments of the present disclosure, the first quaternization reaction is conducted at a temperature of 10° C. to 45° C., preferably 25° C. to 30° C. In some embodiments of the present disclosure, the first quaternization reaction is conducted for 1 h to 12 h, and preferably 6 h to 10 h.

In the present disclosure, there is no particular limitation on an apparatus for the first quaternization, and a reaction apparatus well known to those skilled in the art may be used. The quaternization reaction is preferably conducted in a reactor.

In the present disclosure, after obtaining the second polymer solution, the second polymer solution is mixed with an aqueous solution of a first fluorophosphate, and a resulting mixture is subjected to a first ion exchange reaction, to obtain the ionic polymer binder. The halide ions in the polymer undergo ion exchange reaction with the fluorophosphate ions.

In some embodiments of the present disclosure, the first fluorophosphate is one or more of ammonium hexafluorophosphate, sodium hexafluorophosphate, and potassium hexafluorophosphate. In some embodiments, the aqueous solution of the first fluorophosphate has a concentration of 30 wt % to 45 wt %. When the first fluorophosphate includes two or more of the above listed, there is no particular limitation on a ratio between the two or more, and they could be mixed in any ratio. There is no particular limitation on a preparation process of the aqueous solution of the first fluorophosphate, as long as the first fluorophosphate could be dissolved in water.

In some embodiments of the present disclosure, a molar ratio of the first fluorophosphorus to the first halogenated hydrocarbon is in a range of 1:(0.5-1), and preferably 1:(0.5-0.8). Controlling the ratio between the two could make the binder have better bonding performance.

In the present disclosure, there is no special limitation on an operation of mixing the second polymer solution with the aqueous solution of the first fluorophosphate, and a technical scheme for preparing the mixed material well known to those skilled in the art may be adopted.

In some embodiments of the present disclosure, the first ion exchange reaction is conducted at a temperature of 10° C. to 45° C., and preferably 25° C. In some embodiments, the first ion exchange reaction is conducted for 1 h to 12 h, and preferably 6 h to 10 h. Controlling the temperature and time for the ion exchange reaction could avoid the occurrence of side reactions and enable the ion exchange reaction to proceed fully.

In the present disclosure, there is no particular limitation on a device for the ion exchange reaction, and a reaction device well known to those skilled in the art may be used. In some embodiments, the ion exchange reaction is conducted in a reactor.

In some embodiments of the present disclosure, after the ion exchange reaction, an oil-water two-phase mixture of the ionic polymer binder obtained from the first ion exchange reaction is subjected to extraction and separation, vacuum distillation, cooling, filtration, and drying in sequence, to obtain the ionic polymer binder.

In the present disclosure, there is no particular limitation on an operation of the extraction and separation, and operations well known to those skilled in the art may be used. The extraction and separation could realize the removal of an oil phase, to obtain a water-phase dispersion of the ionic polymer binder.

In some embodiments of the present disclosure, there is no particular limitation on an operation of the vacuum distillation; and an operation well known to those skilled in the art may be used, as long as the material could be concentrated to a solid content of 10 wt % to 45 wt %, preferably 20 wt % to 35 wt %. In the present disclosure, the vacuum distillation could realize the removal of water to obtain polymer solution with suitable concentration.

In the present disclosure, there is no particular limitation on a cooling operation, as long as the temperature could be reduced to 5° C. to 10° C. In some embodiments, a concentrated aqueous dispersion of the ionic polymer binder is cooled to a temperature of 5° C. to 10° C., such that the ionic polymer binder is precipitated.

In the present disclosure, there is no particular limitation on a filtering operation, and any operation well known to those skilled in the art may be used.

In some embodiments of the present disclosure, the drying is performed by vacuum drying. In some embodiments, the vacuum drying is conducted at a temperature of 30° C. to 80° C., and preferably 50° C. to 60° C. In some embodiments, the vacuum drying is conducted for 1 h to 24 h, and preferably 12 h to 24 h.

The present disclosure further provides a method for preparing the ionic polymer binder as described in the above technical solutions, including the following steps:
1) mixing a dialkylamino acrylate, water, and a second halogenated hydrocarbon, and subjecting a resulting mixture to a second quaternization reaction, to obtain an aqueous trialkylamino acrylate halide solution;
2) mixing the aqueous trialkylamino acrylate halide solution obtained in step 1) with an aqueous solution of a second fluorophosphate, and subjecting a resulting mixture to a second ion exchange reaction, to obtain a trialkylamino acrylate fluorophosphate; and
3) mixing the trialkylamino acrylate fluorophosphate obtained in step 2), polyethylene glycol acrylate, an acrylate, a second initiator, and water, and subjecting a resulting mixture to a second free radical polymerization, to obtain the ionic polymer binder having the chemical structure shown in formula I where z>0; wherein
under the condition that the acrylate in step 3) is omitted, the ionic polymer binder having the chemical structure shown in formula I where z=0 is obtained; and
under the condition that the polyethylene glycol acrylate and the acrylate in step 3) are omitted, the ionic polymer binder having the chemical structure shown in formula II is obtained.

In the present disclosure, there is no special limitation on a source of each raw material, and commercially available products well known to those skilled in the art may be used.

In the present disclosure, a dialkylamino acrylate, water, and a second halogenated hydrocarbon are mixed, and a resulting mixture is subjected to a second quaternization reaction, to obtain an aqueous trialkylamino acrylate halide solution.

In some embodiments of the present disclosure, the dialkylamino acrylate is of the same type as the aforementioned dialkylamino acrylate, and will not be repeated herein.

In some embodiments of the present disclosure, the second halogenated hydrocarbon is of the same type as the first halogenated hydrocarbon, and will not be repeated herein.

In some embodiments of the present disclosure, a molar ratio of the dialkylamino acrylate to the second halogenated hydrocarbon is in a range of (0.5-1):(0.5-1), and preferably (0.5-0.8):(0.5-0.8). In the present disclosure, controlling the ratio between the two could make each component react fully.

In some embodiments of the present disclosure, mixing the dialkylamino acrylate, water, and the second halogenated hydrocarbon is performed as follows: mixing the dialkylamino acrylate with water, and then adding a resulting mixture dropwise into the second halogenated hydrocarbon. In the present disclosure, there is no particular limitation on a rate of the adding dropwise, which may be determined based on common sense. In the present disclosure, the adding dropwise could avoid overheating resulted from the reaction.

In some embodiments of the present disclosure, a concentration of the dialkylamino acrylate in the mixture obtained by mixing the dialkylamino acrylate with water is in a range of 30 wt % to 45 wt %.

In some embodiments of the present disclosure, the temperature and time of the second quaternization reaction are as same as those of the first quaternization reaction, and will not be repeated herein.

In the present disclosure, after obtaining the aqueous trialkylamino acrylate halide solution, the aqueous trialkylamino acrylate halide solution is mixed with an aqueous solution of a second fluorophosphate, and a resulting mixture is subjected to a second ion exchange reaction, to obtain a trialkylamino acrylate fluorophosphate.

In some embodiments of the present disclosure, the aqueous solution of the second fluorophosphate is as same as the aqueous solution of the first fluorophosphate, and will not be repeated herein.

In some embodiments of the present disclosure, a molar ratio of the dialkylamino acrylate, the second halogenated hydrocarbon, and the second fluorophosphonate is in a range of (0.5-1):(0.5-1):1, and preferably (0.5-0.8):(0.5-0.8):1. In the present disclosure, controlling the ratio among the three could ensure the reaction proceeds fully.

In the present disclosure, there is no special limitation on an operation of mixing the aqueous trialkylamino acrylate halide solution and the aqueous solution of the second fluorophosphate, and a well-known technical scheme for preparing the mixed material could be used.

In some embodiments of the present disclosure, the temperature and time of the second ion exchange reaction are as same as those of the first ion exchange reaction, and will not be described in detail herein.

In some embodiments of the present disclosure, after the second ion exchange reaction, a product obtained from the second ion exchange reaction is subjected to filtration and then dried, to obtain the trialkylamino acrylate fluorophosphate.

In the present disclosure, there is no particular limitation on a filtration operation, and any operation well known to those skilled in the art may be used.

In some embodiments of the present disclosure, the drying is performed by vacuum drying. In some embodiments, the vacuum drying is conducted at a temperature of 20° C. to 40° C. In some embodiments, the vacuum drying is conducted for 6 h to 24 h, and preferably 12 h to 24 h.

In the present disclosure, after obtaining the trialkylamino acrylate fluorophosphate, the trialkylamino acrylate fluorophosphate, polyethylene glycol acrylate, the acrylate, a second initiator, and water are mixed, and a resulting mixture is subjected to a second free radical polymerization, to obtain the ionic polymer binder having the chemical structure shown in formula I where z>0.

In some embodiments of the present disclosure, the polyethylene glycol acrylate and the acrylate are as same as those described above, and will not be described in detail herein.

In some embodiments of the present disclosure, the second initiator is ammonium persulfate, potassium persulfate, sodium persulfate, 2,2′-azobis[2-methylpropionamidine] dihydrochloride, or 2,2-azobis[2-(2-imidazolin-2-yl)propane] dihydrochloride.

In some embodiments of the present disclosure, a mass of the second initiator is in a range of 0.1% to 2%, preferably 0.3% to 0.5%, and more preferably 0.4% of a total mass of the trialkylamino acrylate fluorophosphate, polyethylene glycol acrylate, and the acrylate. In the present disclosure, controlling the amount of the second initiator within the above range could promote the free radical polymerization to proceed fully.

In some embodiments of the present disclosure, a molar ratio of the trialkylamino acrylate fluorophosphate, the polyethylene glycol acrylate, and the acrylate is in a range of 1:(0.1-1.1):(0.1-1.1), and preferably 1:(0.5-1.0):(0.5-1.0).

In the present disclosure, there is no particular restriction on the amount of the water used, as long as a total mass concentration of the trialkylamino acrylate fluorophosphate, polyethylene glycol acrylate, and the acrylate is maintained within preferably 10% to 50%, more preferably 20% to 30%. In the present disclosure, controlling the amount of the water within the above range could promote the free radical polymerization to proceed fully.

In the present disclosure, there is no special limitation on an operation of mixing the trialkylamino acrylate fluorophosphate, polyethylene glycol acrylate, the acrylate, the second initiator, and water, and a technical scheme for preparing a mixed material well known to those skilled in the art may be adopted.

In some embodiments of the present disclosure, an operation of the second free radical polymerization is as same as that of the first free radical polymerization, and will not be described in detail herein.

In some embodiments of the present disclosure, after the second free radical polymerization, a product obtained from the second free radical polymerization is subjected to vacuum distillation, cooling, filtration, and drying in sequence, to obtain the ionic polymer binder having the chemical structure shown in formula I where z>0.

In the present disclosure, there is no particular limitation on an operation of the vacuum distillation; and an operation well known to those skilled in the art may be used, as long as the material could be concentrated to a solid content of preferably 10 wt % to 50 wt %, more preferably 20 wt % to 35 wt %. In the present disclosure, the vacuum distillation could realize the removal of water to obtain polymer solution with suitable concentration.

In the present disclosure, there is no particular limitation on a cooling operation, as long as the temperature could be reduced to 5° C. to 10° C. In some embodiments, a concentrated aqueous dispersion of the ionic polymer binder is cooled to a temperature of 5° C. to 10° C., such that the ionic polymer binder is precipitated.

In the present disclosure, there is no particular limitation on a filtration operation, and any operation well known to those skilled in the art may be used.

In some embodiments of the present disclosure, the drying is performed by vacuum drying. In some embodiments, the vacuum drying is conducted at a temperature of 30° C. to 80° C., preferably 50° C. to 60° C. In some embodiments, the vacuum drying is conducted for 1 h to 24 h, and preferably 12 h to 24 h.

In the present disclosure, the ionic polymer binder having the chemical structure shown in formula I where z=0 is obtained under the condition that the acrylate is omitted; and the ionic polymer binder having the chemical structure shown in formula II is obtained under the condition that the polyethylene glycol acrylate and the acrylate are omitted.

The present disclosure further provides use of the ionic polymer binder as described in the above technical solutions or the ionic polymer binder prepared by the method as described in the above technical solutions in a cathode of a lithium-ion battery.

In some embodiments of the present disclosure, the cathode of a lithium-ion battery is prepared by a process including the following steps:
(i) mixing the ionic polymer binder with a second organic solvent, to obtain a binder solution;
(ii) mixing an active material with a conductive agent, to obtain a mixed powder;
(iii) mixing the binder solution obtained in step (i), the mixed powder obtained in step (ii), and a third organic solvent, to obtain a cathode slurry; and
(iv) applying the cathode slurry obtained in step (iii) onto a current collector, to obtain the cathode of the lithium-ion battery;
wherein step (i) and step (ii) are conducted in any order.

In the present disclosure, the ionic polymer binder is mixed with a second organic solvent, to obtain a binder solution.

In some embodiments of the present disclosure, the second organic solvent is one or more of NMP, THF, and acetonitrile. In the present disclosure, the second organic solvent as described above have excellent solubility for the ionic polymer binder.

In the present disclosure, there is no particular limitation on the amount of the second organic solvent, as long as the amount could result in a viscosity of the binder solution within 0.1-10 Pa·s. In the present disclosure, when the viscosity of the binder solution is within the above range, the ionic polymer binder could be fully dissolved and it is beneficial to control the slurry to have an appropriate viscosity.

In some embodiments of the present disclosure, PVDF is further added into the binder solution. In some embodiments, a mass ratio of the ionic polymer binder to PVDF is in a range of 1:(0.1-1).

In the present disclosure, there is no special limitation on an operation of mixing the ionic polymer binder with the second organic solvent, and a technical scheme for preparing a mixed material well known to those skilled in the art could be adopted.

In the present disclosure, an active material is mixed with a conductive agent, to obtain a mixed powder.

In some embodiments of the present disclosure, the active material includes lithium iron phosphate (LiFePO₄), lithium cobalt oxide (LiCoO₂), lithium manganate (LiMn₂O₄), nickel cobalt manganese oxide (LiNi_{0.8}Co_{0.1}Mn_{0.1}O₂), or lithium titanate (Li₄Ti₅O₁₂). The above-mentioned types of active materials could make the lithium-ion battery have good electrochemical performance.

In some embodiments of the present disclosure, the conductive agent includes one or more of superconducting carbon, carbon nanotubes, acetylene black, and Ketjen black. The above-mentioned types of conductive agents could make the lithium-ion battery have good electrochemical performance.

In some embodiments of the present disclosure, a mass ratio of the active material, the conductive agent, and the ionic polymer binder is in a range of (60-98):(1-20):(1-20), and preferably (88-96):(2-6):(2-6). By controlling the mass ratio of the active material, the conductive agent, and the ionic polymer binder within the above range, the lithium-ion battery could have good electrochemical performance.

In some embodiments of the present disclosure, mixing the active material and the conductive agent includes: subjecting the active material and the conductive agent to ball milling at room temperature at a rotation speed of 600 rpm to 1,200 rpm for 1 h to 4 h, preferably at a rotation speed of 800 rpm to 1,000 rpm for 2 to 3 h. In the present disclosure, the above process could make the active material and the conductive agent be mixed evenly.

In the present disclosure, after obtaining the binder solution and the mixed powder, the binder solution, the mixed powder, and the third organic solvent are mixed, to obtain a cathode slurry.

In some embodiments of the present disclosure, the third organic solvent is NMP.

In some embodiments of the present disclosure, a total concentration of the mixed powder and the binder in the cathode slurry is in a range of 40 wt % to 65 wt %, and preferably 50 wt % to 60 wt %.

In some embodiments of the present disclosure, mixing the binder solution, the mixed powder, and the third organic solvent includes: subjecting the mixed powder and the binder solution to ball milling at a rotation speed of 600 rpm to 1,200 rpm for 1 h to 10 h, and then adding the third organic solvent thereto, and continuing the ball milling for 1 h to 4 h; preferably subjecting the mixed powder and the binder solution to ball milling at a rotation speed of 800 rpm to 1,000 rpm for 5 h to 8 h, and then adding the third organic solvent thereto, and continuing the ball milling for 2 h to 3 h. In the present disclosure, the above mixing operation and the control of its parameters within the above range are more conducive to the full and uniform mixing of the raw materials.

In the present disclosure, after obtaining the cathode slurry, the cathode slurry is applied onto a current collector, to obtain the cathode of a lithium-ion battery.

In some embodiments of the present disclosure, the current collector is an aluminum foil. There is no special limitation on a size of the aluminum foil, which could be adjusted according to actual demands.

In some embodiments of the present disclosure, the applying is conducted using a scraper. There is no particular limitation on a model of the scraper, and any equipment well known to those skilled in the art may be used.

In the present disclosure, there is no particular limitation on a thickness of the cathode slurry coating, which could be adjusted according to conventional demands. In some embodiments, the applying is conducted to reach a thickness of 60 μm to 500 μm.

In some embodiments of the present disclosure, a product obtained from the applying is subjected to drying, rolling, and cutting into pieces in sequence, to obtain the cathode of a lithium-ion battery.

In some embodiments of the present disclosure, the drying includes atmospheric pressure drying and vacuum drying conducted in sequence. In some embodiments, the atmospheric pressure drying is conducted at a temperature of 40° C. to 60° C. In some embodiments, the atmospheric pressure drying is conducted for 6 h to 24 h. In some embodiments, the atmospheric pressure drying is conducted at 80° C. In some embodiments, the atmospheric pressure drying is conducted for 6 h to 24 h.

In the present disclosure, there is no special limitation on the operations of rolling and cutting, and operations well known to those skilled in the art may be adopted.

In the present disclosure, the ionic polymer binder is used as a binder for the cathode of a lithium-ion battery. An interaction between hexafluorophosphate group in the ionic polymer binder and a cathode active material could enhance bonding among the materials and the conductivity of lithium ions. The polyethylene glycol acrylate could improve the flexibility of the binder and soften the electrode. Since the active material of the cathode is sensitive to water, the introduction of the acrylate as a hydrophobic segment reduces the hydrophilicity of the polymer, thus avoiding a decrease in battery capacity and recycling performance after the active material absorbing water. This makes a lithium-ion battery assembled using the binder have a relatively high specific capacity, capacity retention, and recycling stability.

In the present disclosure, the ionic polymer binder is used as a binder for the cathode of a lithium-ion battery. Since the ionic polymer binder has excellent bonding capability, when preparing the cathode of a lithium-ion battery by using the ionic polymer binder, an active material loading capacity of the cathode could be thereby increased, and the electrode is smooth without curling and cracking. Moreover, the lithium-ion battery assembled with the binder has advantages of high specific capacity, desirable recycling stability, and long service life.

The technical solutions of the present disclosure will be clearly and completely described below in conjunction with the examples of the present disclosure. Apparently, the described examples are merely a part rather than all of the examples of the present disclosure. All other examples obtained by those of ordinary skill in the art based on the examples of the present disclosure without creative efforts shall fall within the scope of the present disclosure.

### Example 1

An ionic polymer binder had a chemical structure as follows:

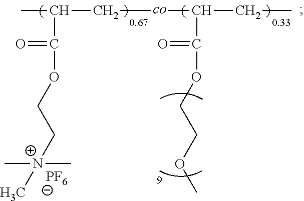

in formula I, R₁ was hydrogen, R₂ was methyl, R₃ was hydrogen, x=0.67, y=0.33, z=0, m=2, n=9; and
the ionic polymer binder had a molecular weight of 5.81×10⁴ Da.

The ionic polymer binder was prepared according to the following procedures:

(1) In a nitrogen atmosphere, 1,106 g of dimethylaminoethyl acrylate, 1,894 g of polyethylene glycol acrylate, 12 g of AIBN, and 7,000 g of DMC were mixed in a reactor, and a resulting mixture was subjected to free radical polymerization at 70° C. for 8 h, to obtain a first polymer solution.

(2) 2,750 g of a 40 wt % methyl iodide solution in DMC was added dropwise into the first polymer solution obtained in step (1), and a resulting mixture was stirred at 25° C. for 6 h, i.e., undergoing quaternization reaction, to obtain a second polymer solution.

(3) The second polymer solution obtained in step (2) was added dropwise into 8,393 g of a 30 wt % aqueous solution of ammonium hexafluorophosphate, and a resulting mixture was stirred at 25° C. for 6 h, i.e., undergoing ion exchange reaction, to obtain an oil-water two-phase mixture containing the ionic polymer binder; extraction and separation were conducted, and a resulting oil phase was removed, to obtain an aqueous dispersion of the ionic polymer binder. The aqueous dispersion was concentrated to a solid content of 35 wt % by vacuum distillation. The resulting concentrated system was then cooled to 5° C., and the ionic polymer binder was precipitated, followed by filtration. The resulting solid was vacuum-dried at 60° C. for 12 h, to obtain 3,898 g of the ionic polymer binder, recorded as A1.

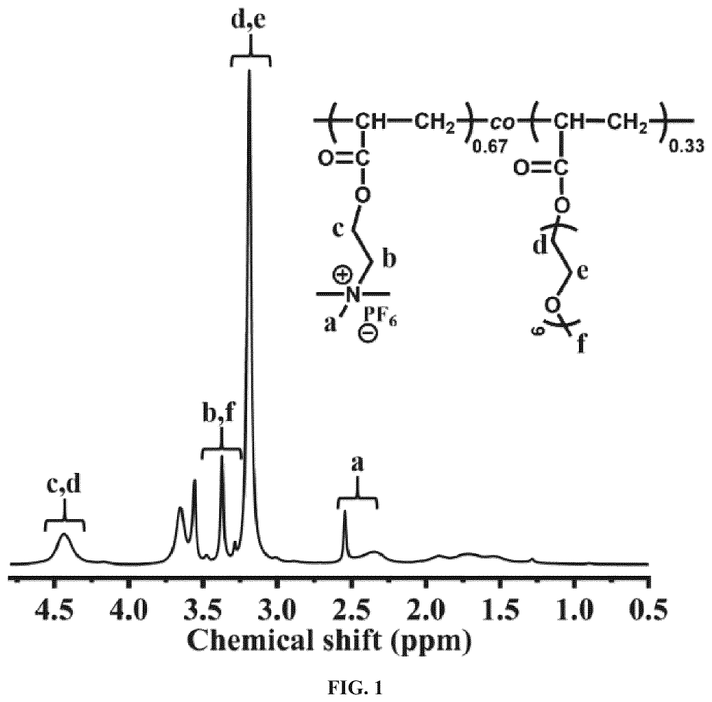

FIG. 1 shows an 1H-NMR spectrum of the ionic polymer binder prepared in Example 1.

### Example 2

An ionic polymer binder had a chemical structure as follows:

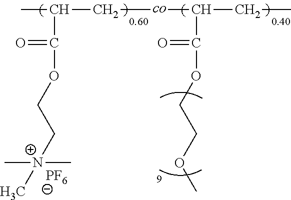

in formula I, R₁ was hydrogen, R₂ was methyl, R₃ was hydrogen, x=0.60, y=0.40, z=0, m=2, n=9; and
the ionic polymer binder had a molecular weight of 5.51×10⁴ Da.

The ionic polymer binder was prepared according to the following procedures:

(1) In a nitrogen atmosphere, 924 g of dimethylaminoethyl acrylate, 2,076 g of polyethylene glycol acrylate, 12 g of AIBN, and 7,000 g of DMC were mixed in a reactor, and a resulting mixture was subjected to free radical polymerization at 70° C. for 8 h, to obtain a first polymer solution.

(2) 2,277 g of a 40 wt % methyl iodide solution in DMC was added dropwise into the first polymer solution obtained step (1), and a resulting mixture was stirred at 25° C. for 6 h, i.e., undergoing quaternization reaction, to obtain a second polymer solution.

(3) The second polymer solution obtained in step (2) was added dropwise into 7,020 g of a 30 wt % aqueous solution of ammonium hexafluorophosphate, and a resulting mixture was stirred at 25° C. for 6 h, i.e., undergoing ion exchange reaction, to obtain an oil-water two-phase mixture containing the ionic polymer binder; extraction and separation were conducted, and a resulting oil phase was removed, to obtain an aqueous dispersion of the ionic polymer binder. The aqueous dispersion was concentrated to a solid content of 35 wt % by vacuum distillation. The resulting concentrated system was then cooled to 5° C., and the ionic polymer binder was precipitated, followed by filtration. The resulting solid was vacuum-dried at 60° C. for 12 h, to obtain 3,711 g of the ionic polymer binder, recorded as A2.

### Example 3

An ionic polymer binder had a chemical structure as follows:

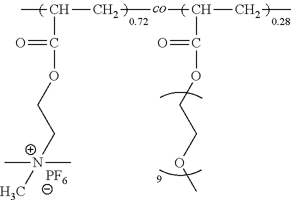

in formula I, R₁ was hydrogen, R₂ was methyl, R₃ was hydrogen, x=0.72, y=0.28, z=0, m=2, n=9; and
the ionic polymer binder had a molecular weight of 6.06×10⁴ Da.

The ionic polymer binder was prepared according to the following procedures:

(1) In a nitrogen atmosphere, 1,278 g of dimethylaminoethyl acrylate, 1,722 g of polyethylene glycol acrylate, 12 g of AIBN, and 7,000 g of DMC were mixed in a reactor, and a resulting mixture was subjected to free radical polymerization at 70° C. for 8 h, to obtain a first polymer solution.

(2) 3,150 g of a 40 wt % methyl iodide solution in DMC was added dropwise into the first polymer solution obtained step (1), and a resulting mixture was stirred at 25° C. for 6 h, i.e., undergoing quaternization reaction, to obtain a second polymer solution.

(3) The second polymer solution obtained in step (2) was added dropwise into 9,710 g of a 30 wt % aqueous solution of ammonium hexafluorophosphate, and a resulting mixture was stirred at 25° C. for 6 h, i.e., undergoing ion exchange reaction, to obtain an oil-water two-phase mixture containing the ionic polymer binder; extraction and separation were conducted and the resulting oil phase was removed, to obtain an aqueous dispersion of the ionic polymer binder. The aqueous dispersion was concentrated to a solid content of 35 wt % by vacuum distillation. The resulting concentrated system was then cooled to 5° C., and the ionic polymer binder was precipitated, followed by filtration. The resulting solid was vacuum-dried at 60° C. for 12 h, to obtain 4,076 g of the ionic polymer binder, recorded as A3.

### Example 4

An ionic polymer binder had a chemical structure as follows:

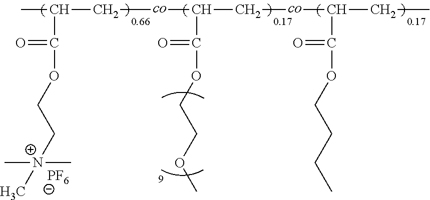

in formula I, R₁ was hydrogen, R₂ was methyl, R₃ and R₄ were hydrogen, R₅ was butyl, x=0.66, y=0.17, z=0.17, m=2, n=9;
the ionic polymer binder had a molecular weight of 6.35×10⁴ Da.

The ionic polymer binder was prepared according to the following procedures:

(1) In a nitrogen atmosphere, 1,452 g of dimethylaminoethyl acrylate, 1,223 g of polyethylene glycol acrylate, 325 g of butyl acrylate, 12 g of AIBN, and 7,000 g of DMC were mixed in a reactor, and a resulting mixture was subjected to free radical polymerization at 70° C. for 8 h, to obtain a first polymer solution.

(2) 3,580 g of a 40 wt % methyl iodide solution in DMC was added dropwise into the first polymer solution obtained step (1), and a resulting mixture was stirred at 25° C. for 6 h, i.e., undergoing quaternization reaction, to obtain a second polymer solution.

(3) The second polymer solution obtained in step (2) was added dropwise into 11,034 g of a 30 wt % aqueous solution of ammonium hexafluorophosphate, and a resulting mixture was stirred at 25° C. for 6 h, i.e., undergoing ion exchange reaction, to obtain an oil-water two-phase mixture containing the ionic polymer binder; extraction and separation were conducted and the resulting oil phase was removed, to obtain an aqueous dispersion of the ionic polymer binder. The aqueous dispersion was concentrated to a solid content of 35 wt % by vacuum distillation. The resulting concentrated system was then cooled to 5° C., and the ionic polymer binder was precipitated, followed by filtration, the resulting solid was vacuum-dried at 60° C. for 12 h, to obtain 4, 155 g of the ionic polymer binder, recorded as A4.

### Example 5

An ionic polymer binder had a chemical structure as follows:

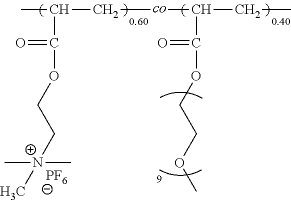

in formula I, R₁ was hydrogen, R₂ was methyl, R₃ was hydrogen, x=0.60, y=0.40, z=0, m=2, n=9; and
the ionic polymer binder had a molecular weight of 6.74×10⁴ Da.

The ionic polymer binder was prepared according to the following procedures:
in a nitrogen atmosphere, 971 g of trimethylaminoethyl acrylate fluorophosphate, 1,029 g of polyethylene glycol acrylate, 8 g of potassium persulfate, and 8,000 g of water were mixed in a reactor, and a resulting mixture was subjected to free radical polymerization at 70° C. for 8 h, to obtain an aqueous dispersion of the ionic polymer binder. The aqueous dispersion was concentrated to a solid content of 35 wt % by vacuum distillation. The resulting concentrated system was then cooled to 5° C., and the ionic polymer binder was precipitated, followed by filtration. The resulting solid was vacuum-dried at 60° C. for 12 h, to obtain 1,863 g of the ionic polymer binder, recorded as A5.

The trimethylaminoethyl acrylate fluorophosphonate had a structural formula shown below:

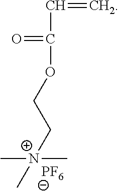

The trimethylaminoethyl acrylate fluorophosphonate was prepared according to the following procedures:

(1) 197 g of methyl iodide was added dropwise into 667 g of a 30 wt % aqueous solution of dimethylaminoethyl acrylate, and a resulting mixture was stirred at 25° C. for 6 h, i.e., undergoing quaternization reaction, to obtain an aqueous solution of trimethylaminoethyl acrylate iodide.

(2) 1,014 g of a 45 wt % aqueous solution of ammonium hexafluorophosphate was added dropwise into the aqueous solution of the trimethylaminoethyl acrylate iodide obtained in step (1), and a resulting mixture was stirred at 25° C. for 8 h, i.e., undergoing ion exchange reaction, and a white precipitate was precipitated, followed by filtration. The resulting solid was vacuum-dried at 30° C. for 12 h, to obtain 401 g of the trimethylaminoethyl acrylate fluorophosphonate.

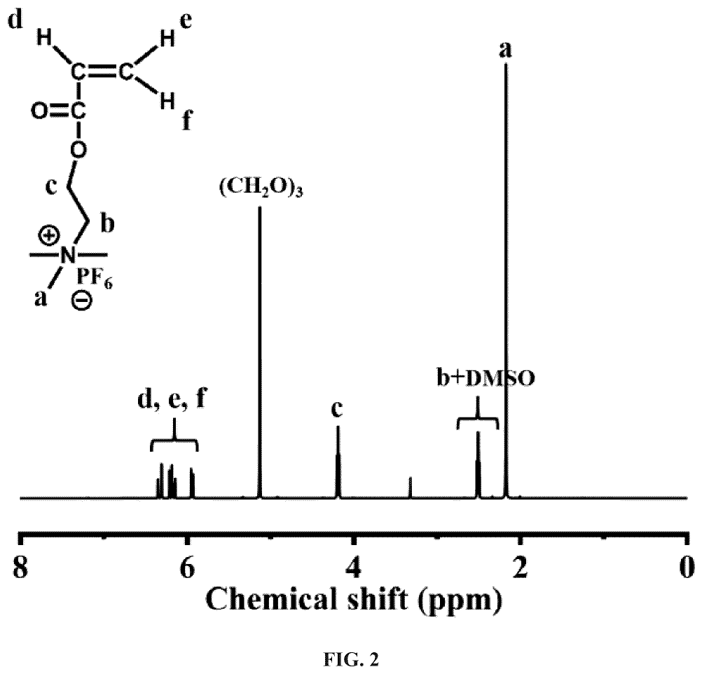

FIG. 2 shows an 1H-NMR spectrum of trimethylaminoethyl acrylate fluorophosphonate in Example 5.

### Example 6

An ionic polymer binder had a chemical structure as follows:

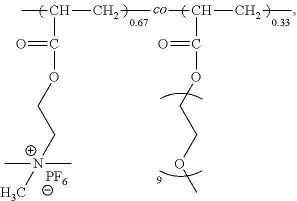

in formula I, R₁ was hydrogen, R₂ was methyl, R₃ was hydrogen, x=0.67, y=0.33, z=0, m=2, n=9; and
the ionic polymer binder had a molecular weight of 9.01×10⁴ Da.

The ionic polymer binder was prepared according to the following procedures:
in nitrogen atmosphere, 1,114 g of trimethylaminoethyl acrylate fluorophosphate, 886 g of polyethylene glycol acrylate, 6 g of potassium persulfate, and 8,000 g of water were mixed in a reactor, and a resulting mixture was subjected to free radical polymerization at 70° C. for 8 h, to obtain an aqueous dispersion of the ionic polymer binder. The aqueous dispersion was concentrated to a solid content of 35 wt % by vacuum distillation. The resulting concentrated system was then cooled to 5° C., and the ionic polymer binder was precipitated, followed by filtration. The resulting solid was vacuum-dried at 60° C. for 12 h, to obtain 1,879 g of the ionic polymer binder, recorded as A6. The trimethylaminoethyl acrylate fluorophosphate was prepared according the same procedures as described in Example 5.

### Example 7

An ionic polymer binder had a chemical structure as follows:

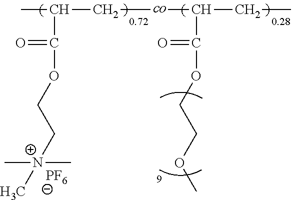

in formula I, R₁ was hydrogen, R₂ was methyl, R₃ was hydrogen, x=0.72, y=0.28, z=0, m=2, n=9; and
the ionic polymer binder had a molecular weight of 7.68×10⁴ Da.

The ionic polymer binder was prepared according to the following procedures:
in a nitrogen atmosphere, 1,222 g of trimethylaminoethyl acrylate fluorophosphate, 778 g of polyethylene glycol acrylate, 10 g of potassium persulfate, and 8,000 g of water were mixed in a reactor, and a resulting mixture was subjected to free radical polymerization at 70° C. for 8 h, to obtain an aqueous dispersion of the ionic polymer binder. The aqueous dispersion was concentrated to a solid content of 35 wt % by vacuum distillation. The resulting concentrated system was then cooled to 5° C., and the ionic polymer binder was precipitated, followed by filtration. The resulting solid was vacuum-dried at 60° C. for 12 h, to obtain 1,895 g of the ionic polymer binder, recorded as A7. The trimethylaminoethyl acrylate fluorophosphate was prepared according to the same procedures as described in Example 5.

### Example 8

An ionic polymer binder had a chemical structure as follows:

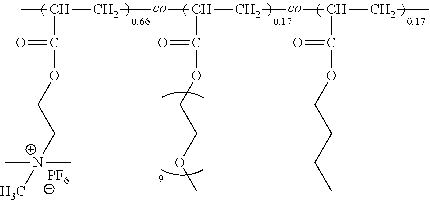

in formula I, R₁ was hydrogen, R₂ was methyl, R₃ and R₄ were hydrogen, R₅ was butyl, x=0.66, y=0.17, z=0.17, m=2, n=9;
the ionic polymer binder had a molecular weight of 8.98×10⁴ Da.

The ionic polymer binder was prepared according to the following procedures:
in a nitrogen atmosphere, 1,330 g of trimethylaminoethyl acrylate fluorophosphate, 529 g of polyethylene glycol acrylate, 141 g of butyl acrylate, 6 g of potassium persulfate, and 8,000 g of water were mixed in a reactor, and a resulting mixture was subjected to free radical polymerization at 70° C. for 8 h, to obtain an aqueous dispersion of the ionic polymer binder. The aqueous dispersion was concentrated to a solid content of 35 wt % by vacuum distillation. The resulting concentrated system was then cooled to 5° C., and the ionic polymer binder was precipitated, followed by filtration. The resulting solid was vacuum-dried at 60° C. for 12 h, to obtain 1,831 g of the ionic polymer binder, recorded as A8. The trimethylaminoethyl acrylate fluorophosphate was prepared according to the procedures as described in Example 5.

### Example 9

An ionic polymer binder had a chemical structure as follows:

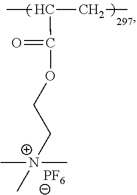

in formula II, R₆ was hydrogen; R₇ was ethylene; R₈, R₉, and R₁₀ were methyl; and q was 297; and
the ionic polymer binder had a molecular weight of 9.01×10⁴ Da.

The ionic polymer binder was prepared according to the following procedures:
in a nitrogen atmosphere, 1,000 g of trimethylaminoethyl acrylate fluorophosphate, 3 g of potassium persulfate, and 4,000 g of water were mixed in a reactor, and a resulting mixture was subjected to free radical polymerization at 70° C. for 8 h, to obtain an aqueous dispersion of the ionic polymer binder. The aqueous dispersion was concentrated to a solid content of 35 wt % by vacuum distillation. The resulting concentrated system was then cooled to 5° C., and the ionic polymer binder was precipitated, followed by filtration. The resulting solid was vacuum-dried at 60° C. for 12 h, to obtain 477 g of the ionic polymer binder, recorded as A9. The trimethylaminoethyl acrylate fluorophosphate was prepared according to the same procedures as described in Example 5.

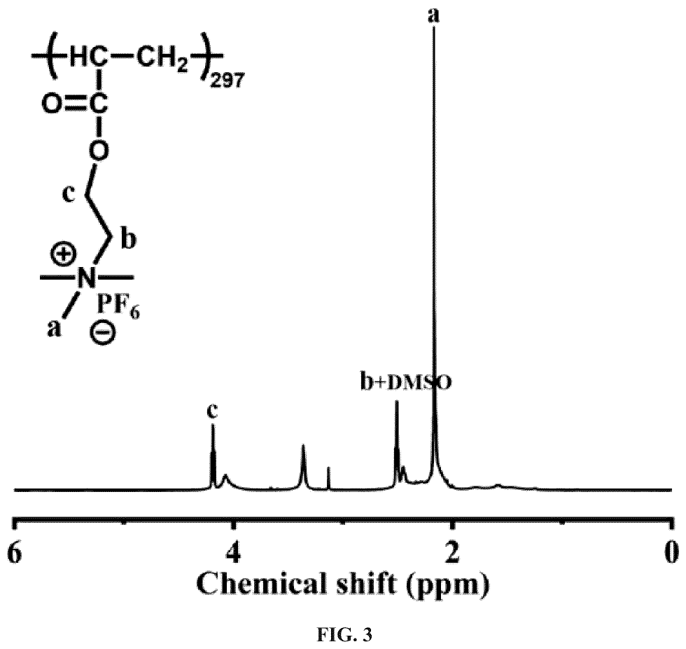

FIG. 3 shows an 1H-NMR spectrum of the ionic polymer binder prepared in Example 9.

### Example 10

An ionic polymer binder had a chemical structure as follows:

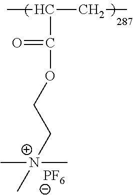

in formula II, R₆ was hydrogen; R₇ was ethylene; R₈, R₉, and R₁₀ were methyl; and q was 287; and
the ionic polymer binder had a molecular weight of 8.69×10⁴ Da.

The ionic polymer binder was prepared according to the following procedures:

(1) In a nitrogen atmosphere, 1,000 g of dimethylaminoethyl acrylate, 4 g of AIBN, and 4,000 g of DMC were mixed in a reactor, and a resulting mixture was subjected to free radical polymerization at 70° C. for 8 h, to obtain a poly(dimethylaminoethyl acrylate) solution.

(2) 3,287 g of a 30 wt % methyl iodide solution in DMC dropwise into the poly(dimethylaminoethyl acrylate) solution obtained in step (1), and a resulting mixture was stirred at 25° C. for 6 h, i.e., undergoing quaternization reaction, to obtain a poly(trimethylaminoethyl acrylate iodide) solution.

(3) The poly(trimethylaminoethyl acrylate iodide) solution obtained in step (2) was added dropwise into 7,597 g of a 30 wt % aqueous solution of ammonium hexafluorophosphate, and a resulting mixture was stirred at 25° C. for 6 h, i.e., undergoing ion exchange reaction, to obtain an oil-water two-phase mixture containing the ionic polymer binder. Extraction and separation were conducted and the resulting oil phase was removed, to obtain an aqueous dispersion of the ionic polymer binder. The aqueous dispersion was concentrated to a solid content of 35 wt % by vacuum distillation. The resulting concentrated system was then cooled to 5° C., and the ionic polymer binder was precipitated, followed by filtration. The resulting solid was vacuum-dried at 60° C. for 12 h, to obtain 1,988 g of the ionic polymer binder, recorded as A10.

### Example 11

An ionic polymer binder had a chemical structure as follows:

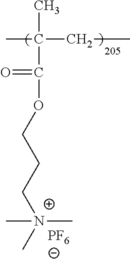

in formula II, R₆ was methyl; R₇ was propylene; R₈, R₉, and R₁₀ were methyl; and q was 205; and
the ionic polymer binder had a molecular weight of 6.76×10⁴ Da.

The ionic polymer binder was prepared according to the following procedures:
in a nitrogen atmosphere, 500 g of 3-(trimethylamino)propyl methacrylate fluorophosphate, 2 g of potassium persulfate, and 2,000 g of water were mixed in a reactor, and a resulting mixture was subjected to free radical polymerization at 70° C. for 8 h, to obtain an aqueous dispersion of the ionic polymer binder. The aqueous dispersion was concentrated to a solid content of 35 wt % by vacuum distillation. The resulting concentrated system was then cooled to 5° C., and the ionic polymer binder was precipitated, followed by filtration. The resulting solid was vacuum-dried at 60° C. for 12 h, to obtain 483 g of the ionic polymer binder, recorded as A11.

The 3-(trimethylamino)propyl methacrylate fluorophosphate had a structural formula shown below:

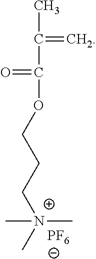

The 3-(trimethylamino)propyl methacrylate fluorophosphate was prepared according to the following procedures:

(1) 412 g of methyl iodide was added dropwise into 1,667 g of a 30 wt % aqueous solution of 3-(dimethylamino)propyl methacrylate, and a resulting mixture was stirred at 25° C. for 6 h, i.e., undergoing quaternization reaction, to obtain an aqueous solution of the 3-(trimethylamino)propyl methacrylate iodide.

(2) 2,117 g of a 45 wt % aqueous solution of ammonium hexafluorophosphate was added dropwise into the aqueous solution of the 3-(trimethylamino)propyl methacrylate iodide obtained in step (1), and a resulting mixture was stirred at 25° C. for 8 h, i.e., undergoing ion exchange reaction, and a white precipitate was precipitated, followed by filtration. The resulting solid precipitate was vacuum dried at 30° C. for 12 h, to obtain 941 g of the 3-(trimethylamino)propyl methacrylate fluorophosphate.

### Example 12

An ionic polymer binder had a chemical structure as follows:

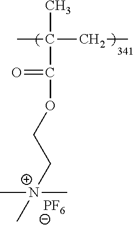

in formula II, R₆ was methyl; R₇ was ethylene; R₈, R₉, and R₁₀ were methyl; and q was 341; and
the ionic polymer binder had a molecular weight of 1.08×10⁵ Da.

The ionic polymer binder was prepared according to the following procedures:
in a nitrogen atmosphere, 1,000 g of trimethylaminoethyl methacrylate fluorophosphate, 2.5 g of potassium persulfate, and 4,000 g of water were mixed in a reactor, and a resulting mixture was subjected to free radical polymerization at 70° C. for 8 h, to obtain an aqueous dispersion of the ionic polymer binder. The aqueous dispersion was concentrated to a solid content of 35 wt % by vacuum distillation. The resulting concentrated system was then cooled to 5° C., and the ionic polymer binder was precipitated, followed by filtration, to obtain a solid product. The solid product was vacuum dried at 60° C. for 12 h, to obtain 485 g of the ionic polymer binder, recorded as A12.

The trimethylaminoethyl methacrylate fluorophosphate had a structural formula shown below:

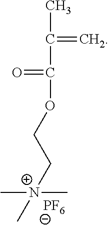

The trimethylaminoethyl methacrylate fluorophosphate was prepared according to the following procedures:

(1) 452 g of methyl iodide was added dropwise into 1,667 g of a 30 wt % aqueous solution of dimethylaminoethyl methacrylate, and a resulting mixture was stirred at 25° C. for 6 h, i.e., undergoing quaternization reaction, to obtain an aqueous solution of the trimethylaminoethyl methacrylate iodide.

(2) 2,307 g of a 45 wt % aqueous solution of ammonium hexafluorophosphate was added dropwise into the aqueous solution of the trimethylaminoethyl methacrylate iodide obtained in step (1), and a resulting mixture was stirred at 25° C. for 8 h, i.e., undergoing ion exchange reaction, such that a white precipitate was precipitated. The resulting precipitate was vacuum dried at 30° C. for 12 h, to obtain 1,002 g of the trimethylaminoethyl methacrylate fluorophosphonate.

### Comparative Example 1

1,000 g of PVDF (HSV900) and 9,000 g of NMP were mixed in a reactor, and a resulting mixture was stirred at 25° C. for 12 h, to obtain a binder solution, recorded as B1.

### Comparative Example 2

400 g of a sodium carboxymethyl cellulose powder (MAC500LC, from Shenzhen Kejing New Materials Co., Ltd, China), 1,712 g of styrene-butadiene rubber latex (S2919, from Shenzhen Kejing New Materials Co., Ltd, China, with a polymer mass fraction of 35%), and 9,000 g of pure water (with resistivity greater than 0.1 MΩ·cm) were mixed in a reactor, and a resulting mixture was stirred at 25° C. for 12 h, to obtain a binder solution, recorded as B2.

### Use Examples 1 to 8

A1 to A8 prepared in Examples 1 to 8 were used as the ionic polymer binder in step 1) of the following method to prepare a cathode of a lithium-ion battery, recorded as C1 to C8 in sequence. For example: the cathode prepared using the ionic polymer binder A1 of Example 1 was recorded as C1, and the remaining were similarly recorded as C2-C8, respectively.

The cathode of a lithium-ion battery was prepared according to the following procedures:

1) 10 g of the ionic polymer binder was dissolved in 90 g of NMP to obtain a binder solution with a viscosity of 102 mPa·s.

2) 180 g of lithium iron phosphate and 10 g of superconducting carbon black were ball-milled at a rotation speed of 1,008 rpm for 2 h, to obtain a mixed powder, wherein a mass ratio of the cathode active material, the conductive agent, and the ionic polymer binder was 90:5:5.

3) The binder solution obtained in step 1) and the mixed powder obtained in step 2) were ball-milled at 1,008 rpm for 4 h, 100 g of NMP was added thereto, and the ball milling was continued for 4 h, to obtain a cathode slurry.

4) The cathode slurry obtained in step 3) was applied onto an aluminum foil with a scraper to a thickness of 250 μm. The aluminum foil coated with the cathode slurry was dried at 60° C. and atmospheric pressure for 12 h, and then vacuum dried at 80° C. for 12 h, rolled, and cut, to obtain the cathode of the lithium-ion battery.

### Use Examples 9 to 16

A1 to A8 prepared in Examples 1 to 8 were used as the ionic polymer binder in step 1) of the following method, and separately dissolved in NMP with PVDF (HSV900) at a mass ratio of 7:3 to obtain a binder solution, and the cathodes of a lithium-ion battery were prepared, recorded as C9 to C16 in sequence. For example, the ionic polymer binder A1 of Example 1 and PVDF were dissolved in NMP at a mass ratio of 7:3, and a prepared cathode was recorded as C9, and the remaining were similarly recorded as C10-C16, respectively.

The cathode of a lithium-ion battery was prepared according to the following procedures:

1) 7 g of the ionic polymer binder and 3 g of PVDF were dissolved in 90 g of NMP to obtain a binder solution with a viscosity of 114 mPa·s.

2) 180 g of lithium iron phosphate and 10 g of superconducting carbon black were ball-milled at a rotation speed of 1,008 rpm for 2 h, to obtain a mixed powder, wherein a mass ratio of the cathode active material, the conductive agent, and the ionic polymer binder was 90:5:5.

3) The binder solution obtained in step 1) and the mixed powder obtained in step 2) were ball-milled at 1,008 rpm for 4 h, 100 g of NMP was added thereto, and the ball milling was continued for 4 h, to obtain a cathode slurry.

4) The cathode slurry obtained in step 3) was applied onto an aluminum foil with a scraper to a thickness of 250 μm. The aluminum foil coated with the cathode slurry was dried at 60° C. and atmospheric pressure for 12 h, and then vacuum dried at 80° C. for 12 h, rolled, and cut, to obtain the cathode of a lithium-ion battery.

### Use Examples 17 to 20

The ionic polymer binder A9 to A12 prepared in Examples 9 to 12 were used as the ionic polymer binder in step 1) of the following method, and separately dissolved in NMP with PVDF (HSV900) at a mass ratio of 8:2 to obtain a binder solution to prepare the cathode of a lithium-ion battery, recorded as C17 to C20 in sequence.

The cathode of a lithium-ion battery was prepared according to the following procedures:

1) 8 g of the ionic polymer binder and 2 g of PVDF were dissolved in 90 g of NMP to obtain a binder solution.

2) 180 g of lithium iron phosphate and 10 g of superconducting carbon black were ball-milled at a rotation speed of 1,008 rpm for 2 h, to obtain a mixed powder, wherein a mass ratio of the cathode active material, the conductive agent, and the ionic polymer binder was 90:5:5.

3) The binder solution obtained in step 1) and the mixed powder obtained in step 2) were ball-milled at 1,008 rpm for 4 h, 100 g of NMP was added thereto, and the ball milling was continued for 4 h, to obtain a cathode slurry.

4) The cathode slurry obtained in step 3) was applied onto an aluminum foil with a scraper to a thickness of 250 μm. The aluminum foil coated with the cathode slurry was dried at 60° C. and atmospheric pressure for 12 h, and then vacuum dried at 80° C. for 12 h, rolled, and cut, to obtain the cathode of a lithium-ion battery.

### Comparative Use Example 1

The cathode of a lithium-ion battery was prepared according to the following procedures:

1) 100 g of the binder B1 prepared in Comparative Example 1 was used as a binder solution.

2) 180 g of lithium iron phosphate and 10 g of superconducting carbon black were ball-milled at a rotation speed of 1,008 rpm for 2 h, to obtain a mixed powder.

3) The binder solution obtained in step 1) and the mixed powder obtained in step 2) were ball-milled at 1,008 rpm for 4 h, 100 g of NMP was added and the ball milling was continued for 4 h, to obtain a cathode slurry.

4) The cathode slurry obtained in step 3) was applied onto an aluminum foil with a scraper to a thickness of 250 μm, the aluminum foil coated with the cathode slurry was dried at 60° C. and atmospheric pressure for 12 h, and then vacuum dried at 80° C. for 12 h, rolled, and cut, to obtain the cathode for a lithium-ion battery, recorded as C21.

### Comparative Use Example 2

The anode of a lithium-ion battery was prepared according to the procedures:

1) 60 g of the binder B2 prepared in Comparative Example 2 was used as a binder solution.

2) 188 g of artificial graphite and 6 g of superconducting carbon black were ball-milled at a rotation speed of 1,008 rpm for 2 h, to obtain a mixed powder.

3) The binder solution obtained in step 1) and the mixed powder obtained in step 2) were ball-milled at 1,008 rpm for 4 h, 136 g of pure water (with resistivity greater than 0.1 MΩ·cm) was added thereto and the ball milling was continued for 4 h, to obtain an anode slurry.

4) The anode slurry obtained in step 3) was applied onto a copper foil with a scraper to a thickness of 300 μm. The copper foil coated with the anode slurry was dried at 60° C. and atmospheric pressure for 12 h, and then vacuum dried at 80° C. for 12 h, rolled, and cut, to obtain the anode of a lithium-ion battery, recorded as C22.

### Test Example 1

The viscosity average molecular weights Mn of the ionic polymer binders prepared in Examples 1 to 12 were separately determined according to the test method of GB/T 10247-2008. The thermal decomposition temperatures of the ionic polymer binders were determined by a thermogravimetric analyzer (TG209, NETZSCH, Germany) in a nitrogen atmosphere from 25° C. to 600° C. at a heating rate of 10° C. min⁻¹. The specific results are shown in Table 1.

TABLE 1
Performance indicators of the ionic polymer binders

| | Viscosity average | |
|---|---|---|
| Ionic polymer | molecular weight M_{η} | Thermal decomposition |
| binders | (Da) | temperature (° C.) |
| A1 | 5.81 × 10⁴ | 326 |
| A2 | 5.51 × 10⁴ | 321 |
| A3 | 6.06 × 10⁴ | 319 |
| A4 | 6.35 × 10⁴ | 323 |
| A5 | 6.74 × 10⁴ | 318 |
| A6 | 9.01 × 10⁴ | 325 |
| A7 | 7.68 × 10⁴ | 317 |
| A8 | 8.98 × 10⁴ | 320 |
| A9 | 9.01 × 10⁴ | 328 |
| A10 | 8.69 × 10⁴ | 321 |
| A11 | 6.76 × 10⁴ | 318 |
| A12 | 1.08 × 10⁵ | 334 |

As shown in Table 1, the molecular weight of the ionic polymer binder was within the range of 5.5×10⁴ Da to 1.1×10⁵ Da, which is much lower than the molecular weight of commercial PVDF, such as PVDF HSV900 (with a molecular weight of 6.0×10⁵ Da). Therefore, it is expected that under the same conditions, the slurry prepared by the ionic polymer binder according to the present disclosure has a lower viscosity and is easier to coat. The ionic polymer binder has a thermal decomposition temperature higher than that of PVDF (316° C.), and thus shows desirable heat resistance and could meet the needs of battery running at high temperature.

### Test Example 2

The density of the active material of the cathodes C1 to C21 of a lithium-ion battery refers to the mass of lithium iron phosphate per unit area, which is determined by calculation. The peel strength between the current collector and the dried slurry coating on the surface of the current collector in the electrode was measured according to the test method of GB/T 2791-1995. The density and peel strength are shown in Table 2.

A lithium iron phosphate/metal lithium battery was assembled using the prepared C1 to C21 as the cathode and lithium metal as the anode according to the following procedures:

A commercial lithium hexafluorophosphate electrolyte with a concentration of 1 mol/L was used as an electrolyte; a molar ratio of ethylene carbonate, DMC, and diethyl carbonate (DEC) was 1:1:1; and a polypropylene microporous membrane (Celgard 2325) was used as a separator, to obtain the lithium iron phosphate/metal lithium battery.

The battery specific capacity refers to the initial discharge specific capacity and the 500th cycle discharge specific capacity of the assembled lithium iron phosphate/metal lithium battery at a current density of 0.5 C. A test instrument was a battery recycling tester (Wuhan Blue Electric Electronics Co., Ltd., China, CT3002A), with a cut-off voltage of 2.5 V to 4.2 V, a test temperature of 25° C., and a theoretical specific capacity of the active material of 170 mAh/g. The results of the density, peel strength of the lithium iron phosphate electrode, and initial discharge capacity, 500th cycle discharge specific capacity and retention (a ratio of discharge capacity to the initial discharge capacity) of the battery are shown in Table 2.

TABLE 2
Performance indicators of lithium iron phosphate/metal lithium battery.

| | Density of | | Initial discharge | |
|---|---|---|---|---|
| | lithium iron | Peel | specific | 500th cycle discharge |
| Battery | phosphate | strength | capacity (mAh | specific capacity (mAh |
| cathode | (mg · cm⁻²) | (N · cm⁻¹) | g⁻¹) | g⁻¹) and retention |
| C1 | 16.1 | 17.7 | 149.5 | 140.9 (94.25%) |
| C2 | 15.2 | 11.4 | 145.6 | 136.8 (93.96%) |
| C3 | 15.3 | 14.2 | 143.7 | 133.7 (93.04%) |
| C4 | 15.7 | 16.5 | 147.5 | 137.7 (93.36%) |
| C5 | 15.5 | 10.1 | 141.1 | 131.3 (93.05%) |
| C6 | 15.4 | 12.5 | 140.9 | 131.1 (93.04%) |
| C7 | 15.5 | 14.7 | 141.4 | 130.7 (92.43%) |
| C8 | 15.7 | 13.8 | 141.2 | 130.8 (92.63%) |
| C9 | 15.1 | 32.1 | 138.8 | 127.4 (91.79%) |
| C10 | 15.9 | 37.8 | 139.9 | 131.1 (93.70%) |
| C11 | 15.5 | 30.9 | 137.9 | 125.6 (91.08%) |
| C12 | 15.8 | 36.9 | 138.4 | 128.8 (93.06%) |
| C13 | 15.5 | 29.3 | 138.2 | 127.3 (92.11%) |
| C14 | 15.3 | 31.5 | 141.1 | 131.3 (93.05%) |
| C15 | 15.6 | 32.4 | 140.7 | 129.2 (91.83%) |
| C16 | 15.4 | 31.8 | 140.3 | 129.0 (91.95%) |
| C17 | 15.7 | 19.5 | 148.3 | 139.5 (94.07%) |
| C18 | 15.3 | 13.7 | 147.9 | 137.7 (93.10%) |
| C19 | 15.5 | 15.1 | 144.6 | 135.0 (93.36%) |
| C20 | 15.2 | 19.2 | 145.2 | 134.8 (92.84%) |
| C21 | 15.1 | 1.6 | 137.1 | 127.1 (92.71%) |

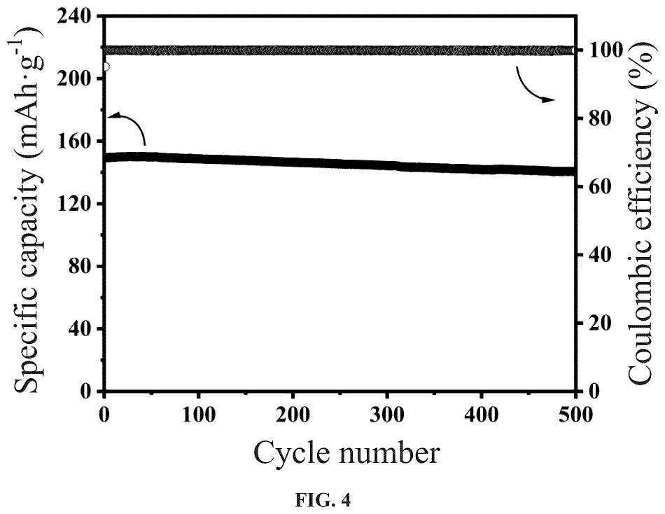

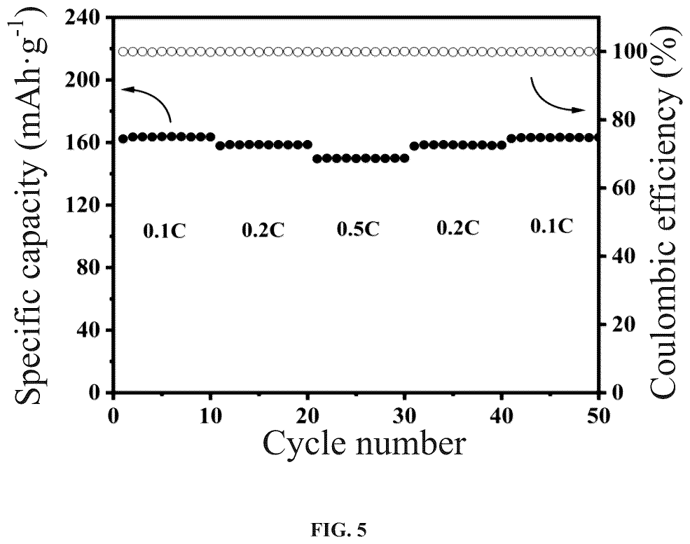

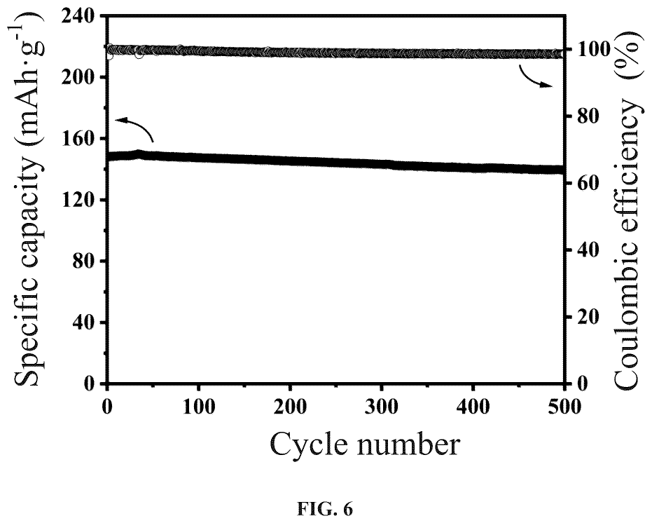

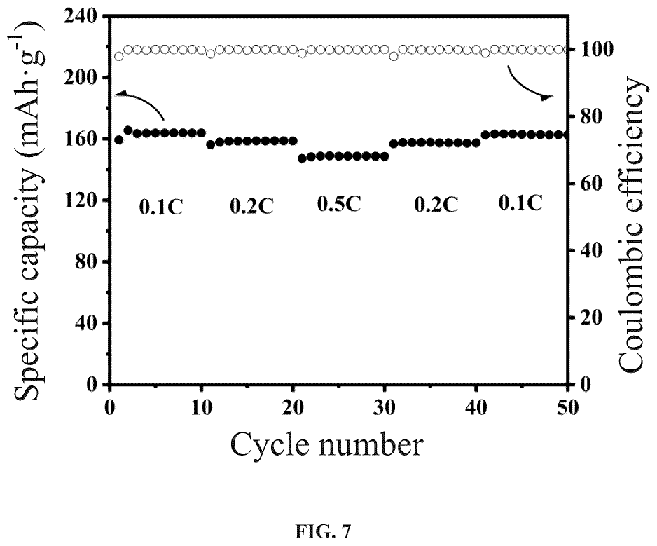

FIG. 4 shows a long recycling charge-discharge curve of the battery assembled with C1 as a battery cathode and lithium metal as a battery anode at 25° C., with a cut-off voltage of 2.5 V to 4.2 V, and a rate of 0.5 C. FIG. 5 shows charge-discharge curves of the battery assembled with C1 as a battery cathode and lithium metal as a battery anode at 25° C., with a cut-off voltage of 2.5 V to 4.2 V, and different rates of 0.1 C, 0.2 C, and 0.5 C. FIG. 6 shows a long recycling charge-discharge curve of the battery assembled with C17 as a battery cathode and lithium metal as a battery anode at 25° C., with a cut-off voltage of 2.5 V to 4.2 V, and a rate of 0.5 C. FIG. 7 shows charge-discharge curves of the battery assembled with C17 as a battery cathode and lithium metal as a battery anode at 25° C., with a cut-off voltage of 2.5 V to 4.2 V, and different rates of 0.1 C, 0.2 C, and 0.5 C.

As shown in Table 2 and FIG. 4 to FIG. 7, under the condition of similar lithium iron phosphate density, the lithium iron phosphate cathodes C9 to C16 prepared with the ionic polymer binder and PVDF at a mass ratio of 7:3 and the lithium iron phosphate cathodes C17 to C20 prepared at a mass ratio of 8:2 have higher peel strength than those of the lithium iron phosphate electrodes C1 to C8 prepared with the ionic polymer binder alone and the lithium iron phosphate cathode C21 prepared with the PVDF binder alone, that is to say, there is a better bonding strength between the active material and the current collector. The lithium iron phosphate/metal lithium battery assembled with the lithium iron phosphate cathodes C1 to C8 and C17 to C20 and metal lithium have a higher initial discharge specific capacity than that of the battery assembled with the lithium iron phosphate cathode C21, and also have a higher discharge specific capacity and capacity retention after 500 cycles at a current density of 0.5 C. Particularly, the lithium iron phosphate/metal lithium batteries assembled with C1 and C17 have the best performance.

### Test Example 3

A lithium iron phosphate/artificial graphite battery was assembled using the prepared C1, C17, or C21 as a lithium iron phosphate cathode and C22 as an artificial graphite anode according to the following procedures:

a commercial lithium hexafluorophosphate electrolyte with a concentration of 1 mol/L was used as an electrolyte; a molar ratio of ethylene carbonate, DMC, and DEC was 1:1:1, and a polypropylene microporous membrane (Celgard 2325) was used as a separator, to obtain the lithium iron phosphate/artificial graphite battery, recorded as D1 to D3, respectively.

The D1 to D3 lithium iron phosphate/artificial graphite batteries were subjected to battery recycling testing in a battery recycling tester (Wuhan Blue Electric Electronics Co., Ltd., China, CT3002A) with a cut-off voltage of 2.5 V to 4.2 V, a test temperature of 25° C., a rate of 0.5 C, and a theoretical specific capacity of the active material of 170 mAh/g. The test results of the initial specific capacity of the battery recycling, the 800th cycle discharge specific capacity, and the capacity retention (a ratio of the discharge specific capacity to the initial discharge specific capacity) are shown in Table 3. The test results of the initial specific capacity, the 1000th cycle discharge specific capacity, and the capacity retention (a ratio of the discharge specific capacity to the initial discharge specific capacity) of the battery are shown in Table 4.

TABLE 3
Performance indicators of lithium iron phosphate/artificial graphite battery

| | | | | 800th cycle discharge |
|---|---|---|---|---|
| Lithium iron | | | Initial discharge | specific capacity |
| phosphate/artificial | | | specific capacity | (mAh g⁻¹) and |
| graphite battery | Cathode | Anode | (mAh g⁻¹) | retention |
| D1 | C1 | C22 | 149.6 | 137.8 (92.11%) |
| D2 | C21 | C22 | 145.7 | 131.3 (90.12%) |

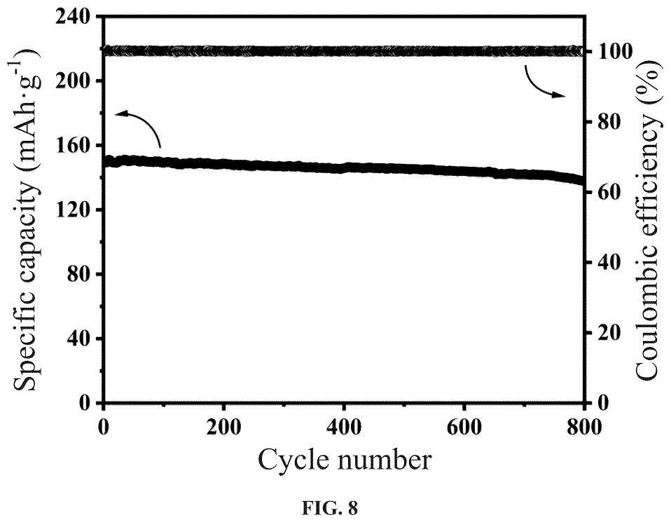

FIG. 8 shows a long recycling charge-discharge curve of the lithium iron phosphate/artificial graphite battery assembled with C1 as a cathode and C22 as an anode at 25° C., with a cut-off voltage of 2.5 V to 4.2 V, and a rate of 0.5 C.

As shown in Table 3 and FIG. 8, the full battery assembled with lithium iron phosphate cathode C1 and artificial graphite anode C22 prepared with SBR/CMC binder has a higher initial discharge specific capacity than that of the full battery assembled with lithium iron phosphate cathode C21 prepared with PVDF binder. After 800 cycles at a current density of 0.5 C, the battery could still maintain a specific capacity of 137.8 mAh g⁻¹, showing capacity retention of 92.11%, and indicating excellent recycling performance.

TABLE 4
Performance indicators of lithium iron phosphate/artificial graphite battery

| Lithium iron | | | Initial discharge | 1,000th cycle discharge |
|---|---|---|---|---|
| phosphate/artificial | | | specific capacity | specific capacity (mAh g⁻¹) |
| graphite battery | Cathode | Anode | (mAh g⁻¹) | and retention |
| D3 | C17 | C22 | 149.5 | 127.1 (85.02%) |
| D2 | C21 | C22 | 145.7 | 123.3 (84.63%) |

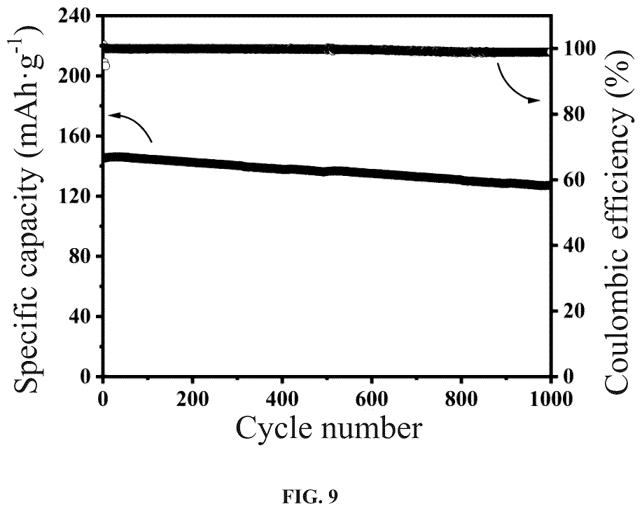

FIG. 9 shows a long recycling charge-discharge curve of the lithium iron phosphate/artificial graphite battery assembled with C17 as a cathode and C22 as an anode at 25° C., with a cut-off voltage of 2.5 V to 4.2 V, and a rate of 0.5 C.

As shown in Table 4 and FIG. 9, the full battery assembled with lithium iron phosphate cathode C17 and artificial graphite anode C22 prepared with SBR/CMC binder have a higher initial discharge specific capacity than that of the battery assembled with lithium iron phosphate electrode C21. The battery also has a higher discharge specific capacity and battery long recycling capacity retention after 1,000 cycles at a current density of 0.5 C.

It can be seen from the above examples that when the ionic polymer binder of the present disclosure is used to prepare a cathode of a lithium-ion battery, there is excellent adhesion to the active material. An interaction between hexafluorophosphate group in the ionic polymer binder and a cathode active material could enhance bonding among the materials, improve the conductivity of lithium ions, and increase the active material loading capacity of the cathode. The polyethylene glycol acrylate could improve the flexibility of the binder and soften the electrode. Since the active material of the cathode is sensitive to water, the introduction of the acrylate as a hydrophobic segment reduces the hydrophilicity of the polymer, thus avoiding a decrease in battery capacity and recycling performance after the active material absorbing water. This makes a lithium-ion battery assembled using the binder have a relatively high specific capacity, capacity retention, and recycling stability; and the electrode is smooth without curling and cracking.

The above descriptions are merely preferred embodiments of the present disclosure. It should be noted that a person of ordinary skill in the art may further make several improvements and modifications without departing from the principle of the present disclosure, but such improvements and modifications should be deemed as falling within the scope of the present disclosure.

What is claimed is:

1. An ionic polymer binder, which has a chemical structure as one selected from the group consisting of formula I and formula II: 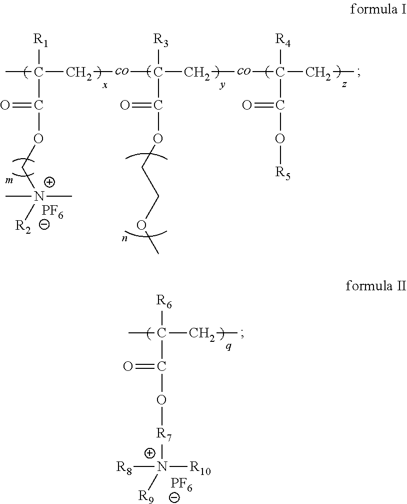
wherein
in formula I, R₁, R₃, and R₄ are independently selected from the group consisting of hydrogen and alkyl, and R₂ and R₅ are independently alkyl; and
in formula II, R₆ is selected from the group consisting of hydrogen and alkyl, R₇ is selected from the group consisting of alkylene and aralkylene, R₈ and R₉ are independently selected from the group consisting of alkyl and aralkyl, and R₁₀ is alkyl.

2. The ionic polymer binder as claimed in claim 1, wherein in formula I, m is an integer in a range of 1 to 3; n is an integer in a range of 4 to 40; and x, y, and z satisfy x+y+z=1, where x>0, y>0, and z≥0.

3. The ionic polymer binder as claimed in claim 1, wherein in formula II, q represents a degree of polymerization and is an integer in a range of 20 to 2,000.

4. A method for preparing the ionic polymer binder as claimed in claim 1, comprising:
(1) mixing a monomer, a first initiator, and a first organic solvent, and subjecting a resulting mixture to a first free radical polymerization, to obtain a first polymer solution;
(2) mixing a first halogenated hydrocarbon, a second solvent, and the first polymer solution obtained in step (1), and subjecting a resulting mixture to a first quaternization reaction, to obtain a second polymer solution; and
(3) mixing the second polymer solution obtained in step (2) with an aqueous solution of a first fluorophosphate, and subjecting a resulting mixture to a first ion exchange reaction, to obtain the ionic polymer binder; wherein
under the condition that the monomer in step (1) is a dialkylamino acrylate, the ionic polymer binder having the chemical structure shown in formula II is obtained;
under the condition that the monomer in step (1) is a mixture of a dialkylamino acrylate and polyethylene glycol acrylate, the ionic polymer binder having the chemical structure shown in formula I where z=0 is obtained; and
under the condition that the monomer in step (1) is a mixture of a dialkylamino acrylate, polyethylene glycol acrylate, and an acrylate, the ionic polymer binder having the chemical structure shown in formula I where z>0 is obtained.

5. The method as claimed in claim 4, wherein the first free radical polymerization in step (1) is conducted at a temperature of 45° C. to 80° C. for 6 h to 24 h.

6. The method as claimed in claim 4, wherein the first quaternization reaction in step (2) is conducted at a temperature of 10° C. to 45° C. for 1 h to 12 h.

7. The method as claimed in claim 4, wherein the first ion exchange reaction in step (3) is conducted at a temperature of 10° C. to 45° C. for 1 h to 12 h.

8. A method for preparing the ionic polymer binder as claimed in claim 1, comprising:
1) mixing a dialkylamino acrylate, water, and a second halogenated hydrocarbon, and subjecting a resulting mixture to a second quaternization reaction, to obtain an aqueous trialkylamino acrylate halide solution;
2) mixing the aqueous trialkylamino acrylate halide solution obtained in step 1) with an aqueous solution of a second fluorophosphate, and subjecting a resulting mixture to a second ion exchange reaction, to obtain a trialkylamino acrylate fluorophosphate; and
3) mixing the trialkylamino acrylate fluorophosphate obtained in step 2), polyethylene glycol acrylate, an acrylate, a second initiator, and water, and subjecting a resulting mixture to a second free radical polymerization, to obtain the ionic polymer binder having the chemical structure shown in formula I where z>0; wherein
under the condition that the acrylate in step 3) is omitted, the ionic polymer binder having the chemical structure shown in formula I where z=0 is obtained; and
under the condition that the polyethylene glycol acrylate and the acrylate in step 3) are omitted, the ionic polymer binder having the chemical structure shown in formula II is obtained.

9. A method for preparing a cathode of a lithium-ion battery, comprising:
(i) mixing the ionic polymer binder as claimed in claim 1 with a second organic solvent, to obtain a binder solution;
(ii) mixing an active material with a conductive agent, to obtain a mixed powder;
(iii) mixing the binder solution obtained in step (i), the mixed powder obtained in step (ii), and a third organic solvent, to obtain a cathode slurry; and
(iv) applying the cathode slurry obtained in step (iii) onto a current collector, to obtain the cathode of the lithium-ion battery;
wherein step (i) and step (ii) are conducted in any order.
